(19) United States
(12) Patent Application Publication
(10) Pub. No.: US 2023/0089819 A1
(43) Pub. Date: Mar. 23, 2023

(54) SOURCE PORT-BASED IDENTIFICATION OF CLIENT ROLE

(71) Applicant: Hewlett Packard Enterprise Development LP, Houston, TX (US)

(72) Inventors: Rajib Majila, Bangalore (IN); Ram lakhan Patel, Bangalore (IN); Vinayak Joshi, Bangalore (IN)

(21) Appl. No.: 17/482,079

(22) Filed: Sep. 22, 2021

(51) Int. Cl. H04L 29/06

(52) U.S. Cl. CPC H04L 63/20; H04L 63/0876

(57) ABSTRACT

One aspect of the instant application facilitates a source port-based identification of client role. During operation, the system can receive, at a network device, a network packet from a client device coupled to the network device via a port. The system can in response to determining that the port is a trusted port, apply a global trusted port configuration based on a first mapping table. The global trusted port configuration corresponds to a default client role. The system can in response to determining that a per-port configuration exists in a second mapping table and the client device is coupled to the trusted port, identify the per-port configuration that corresponds to a port-based client role to override the global trusted port configuration; and apply, based on the per-port configuration and a third mapping table, a policy to the subsequent network packets received via the port.

### BACKGROUND

This disclosure is generally related to a field of networking policies and more particularly to group-based networking policies. In general, network segmentation is applied to isolate user traffic and reduce broadcast domain in the network. Some of the existing authentication methods can be applied to additionally segregate groups of users and assign each group a role. This role can define the network access policies governing the group of users or clients.

### BRIEF DESCRIPTION OF THE FIGURES

FIG. 1A illustrates an example network environment with egress switches equipped with policy engines, according to one aspect of the instant application.

FIG. 1B illustrates an example mapping between a client role, virtual local area network (VLAN), and media access control (MAC) address, according to one aspect of the instant application.

FIG. 2 illustrates an example system architecture for facilitating a source port-based identification of client role, according to one aspect of the instant application.

FIG. 3A illustrates an example first mapping table indicating a mapping between a client role and a client device MAC address, according to one aspect of the instant application.

FIG. 3B illustrates an example second mapping table indicating a mapping between a switch port and port tag, according to one aspect of the instant application.

FIG. 4A presents a flowchart illustrating an example process for performing a source port-based identification of a client role, according to one aspect of the instant application.

FIG. 4B presents a flowchart illustrating an example process for performing a source port-based identification of a client role, according to one aspect of the instant application.

FIG. 5 illustrates an example computer system that facilitates a source port-based identification of client role, according to one aspect of the instant application.

In the figures, like reference numerals refer to the same figure elements.

### DETAILED DESCRIPTION

The following description is presented to enable any person skilled in the art to make and use the examples and is provided in the context of a particular application and its requirements. Various modifications to the disclosed examples will be readily apparent to those skilled in the art, and the general principles defined herein may be applied to other examples and applications without departing from the spirit and scope of the present disclosure. Thus, the scope of the present disclosure is not limited to the examples shown but is to be accorded the widest scope consistent with the principles and features disclosed herein.

Network segmentation is applied to isolate user traffic and reduce the broadcast domain in the network. Traditionally, VLANs have been used to segment the network traffic at Layer-2 (L2) and internet protocol (IP) sub-domains have been used to segment traffic at Layer-3 (L3). Integration of traditional wired and wireless infrastructure, ever increasing number of mobile devices in the network, and deployment of Internet of Things (IoT) devices in large numbers are some of the challenges facing the traditional network segmentation at the network edge. Supporting a large combination of devices with different levels of access conditions and threat perception; and supporting traditional manual and static configurations using IP sub-nets and Access Control Lists (ACLs) may not scale well. Further, it is also desirable to apply similar type of networking policies to the mobile devices as they move across the network.

Modern networks have been subject to a shift in network access and control policies from Virtual Routing and Forwarding (VRF) or VLAN based segmentation and static Access Control Lists (ACLs) governing the network access to a dynamic, scalable, and application centric access control. In other words, instead of segmenting network traffic at a traditional L2 or L3 boundaries, e.g., VLAN, IP subnet, VRF, or statically defining access control between devices, etc., current networking systems apply a distributed and multi-tenanted policy plane that can implement segmentation dynamically with networking policies that are based on applications. Such an infrastructure can be scalable due to grouping of entities that can be associated with a similar policy treatment. Further, such grouping of entities can facilitate the uniform application of policies, e.g., Group based policies (GBPs), across the network irrespective of the physical placement of the devices in the network.

GBPs solve some of the challenges at a network edge by grouping entities based on the policies for the entities and applying GBPs that define network access policies between groups of devices. Specifically, GBPs can facilitate a network administrator to define a level of access permitted to a certain group based on client roles, e.g., a client role can include and is not limited to an administrator, finance, guest, intern, engineer, etc. Client role-based policies define the access between a pair of groups for a given L3 or L4 attributes. Such client role-based policies can result in a policy enforcement that is independent of network parameters, e.g., VLAN or IP subnet, and can provide a uniform policy enforcement across the network.

However, in some cases different grouping mechanisms may be desirable. For example, trusted servers may be connected over trusted ports and may not be authenticated, or there might be external traffic, e.g., internet traffic, for which classifying the source of the traffic may be difficult. Further, in some other cases a number of clients may connect over a secure port, e.g., by using port access method, and each of the clients may be assigned a different role. However, from the policy enforcement point of view it may be desirable to apply a single Security Group Tag (SGT) to such clients instead of applying different GBP tags. Many existing Application Specific Integrated Circuits (ASICs) in a network device and many older generation ASICs lack the capability to support such use cases. Hence, it is desirable to design a system that can identify a role of a traffic sender which can be optionally derived based on the source port through which the traffic sender is coupled to in the egress switch.

Some of the aspects described in this application provide a technical solution to the above-mentioned technical problems by providing a system and method for facilitating a source port-based identification of client role even when the ASIC lacks the capability for performing such a source port-based classification. Specifically, some of the aspects described in this application can apply a source-port configuration to override the individual client role information that is based on the media access control (MAC) address of the client device. For example, the system implementing a policy engine can be aware of a mapping between the MAC source address (SA) and a GBP tag (e.g., a MAC-based tag), the system however may not be aware of a mapping between the MAC SA and a port-based tag. The system can include a mechanism to re-purpose the MAC SA table by replacing the MAC-based tag with a port-based tag, so that the system can apply this port-based tag to perform a policy look-up and apply an appropriate policy to the packet received from a specific switch port.

In one aspect of the instant application, during operation, the system can receive, at a network device, a network packet from a client device coupled to the network device via a trusted port. The received network packet can include a client device identifier, i.e., a MAC SA. Initially, the system may apply a global trusted port configuration based on a first mapping table. For example, the global trusted port configuration can correspond to a default client role assigned to the client device coupled to the trusted port of the network device. Such a global trusted port configuration may assign a single default client role to any client device coupled to trusted ports.

To distinguish between client devices coupled to different trusted ports, the system may include a per-port configuration in a second mapping table. In one aspect, the system may in response to determining that such a per-port configuration exists in the second mapping table, the system may identify the per-port configuration that corresponds to a port-based client role for the trusted port. The system may override the global trusted port configuration with the port-based client role and update an entry in a third mapping table with the port-based client role corresponding to the client device identifier. The system may then apply, based on the per-port configuration and the third mapping table, a policy to the subsequent network packets received via the trusted port. Therefore, the system provides a novel approach to classify client devices based on the ports to which they are coupled and can assign a port-based client role to the client devices. Based on this port-based client role, the system can apply appropriate policies to network packets received via the switch port to which the client device is coupled.

The terms “client” and “user” are used interchangeably in this application.

The phrases “Group Based Policy Tag” and “Security Group Tag” are used interchangeably in this application.”

The term “tag” refers to an integer value assigned to a client role.

### System Architecture and Port-Based Role Identification

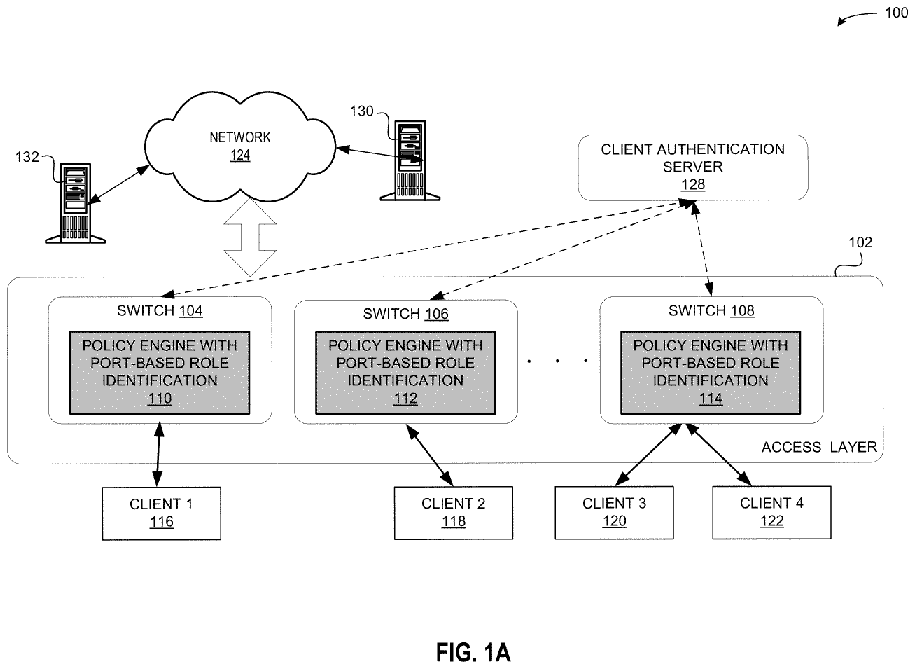

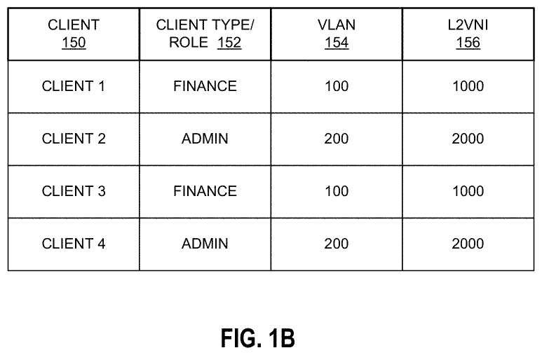

FIG. 1A illustrates an example network environment with egress switches equipped with policy engines, according to one aspect of the instant application. In the example shown in FIG. 1A, environment 100 enables devices, e.g., personal computers 116-122 and servers 130-132, coupled via network 124 to exchange data. Network 124 can include a corporate data center network, a corporate branch network, an external network carrying internet traffic, etc.

A datapath between these devices, i.e., 116-122 and 130-132, via network 124 can often include a number of intermediary datapath devices, e.g., network switches, gateways, and routers for routing data between the devices along a selected datapath. A typical enterprise network deployment can include an access layer 102 that enables clients 116-122 access to network 124 via network switches 104-108. Network switches 104-108 can implement networking policies based on a corresponding policy engine, e.g., policy engines with port-based role identification 110-114. These networking policies can include a set of forwarding rules that can be applied to a packet when some match criteria are satisfied.

A network switch in access layer 102 can include an Application Specific Integrated Circuit (ASIC) or a circuitry for implementing a policy engine, e.g., policy engines 110-114. Network switch, e.g., 104-108, can include a mechanism to authenticate, e.g., with a certificate or a password, a client device whenever the client device, e.g., laptop, IoT devices, etc., is plugged into a network switch in access layer 102. The network switch can then assign clients plugged in to respective VLANs to a specific role or a group.

When egress network switches implement assignment of policies based on a destination role which is a function of the destination MAC address of the client device, the circuitry or ASIC in the egress network switches can look up a policy corresponding to the identified destination role and destination MAC address. For example, when a group of client devices are assigned a specific destination role, the circuitry can then apply, based on the destination role, a GBP to the incoming packets.

GBPs can enable network administrators to configure policies that define permissible traffic patterns across or within security grouping that is defined by user roles. GBP is often configured as a policy between a pair of source and destination roles. GBP can further facilitate both micro and macro segmentation of network traffic based on some application attributes. In existing systems, a sender of the network packet can be profiled at an ingress node and the profiling information can be sent with a special encapsulation. This profiling information is encoded using an identifier which is often referred to as GBP tag. The system may apply the GBP tag to perform policy enforcement.

When applying GBP, the existing systems may perform a check at the enforcement point for the source and destination roles associated with each packet for enforcing the GBP, and various L3/L4 traffic attributes associated with the packet. The GBP enforcement point can be either at the ingress switch, egress switch, at an intermediate switch, or at a unified central enforcement point, e.g., a mobility controller gateway.

However, when the source device is not directly coupled to the egress network switch, a source role may not be known to the egress network switch. Current systems support Virtual Extensible LAN (VxLAN) overlay which can enable an ingress network switch to include a role of the source device, which can be obtained during an authentication process, i.e., facilitated by client authentication server 128 which applies an authentication protocol, with appropriate encapsulation, e.g., encapsulations defined in Internet Engineering Task Force (IETF) drafts. The system may then carry the packet to a peer VxLAN Tunnel End Point (VTEP) using the underlay infrastructure. Since the underlay infrastructure is aware of the role obtained during the authentication process, the system can enforce a GBP by combining the source role obtained from a VxLAN header and destination role which is known to the local switch. Therefore, the system can enforce GBP at every switch for clients, i.e., 116-122, that are directly coupled to the respective switch in access layer 102 for traffic generated by a source in the VxLAN overlay fabric.

Some of the existing systems may perform dynamic segmentation of traffic by applying GBPs at the egress switches. In response to the system applying an authentication process, the system at egress switch can receive a role associated with the destination or client device that is directly coupled to the egress switch. In other words, the system may include information about the roles of a client device directly coupled to the egress switch. Hence, the system can alleviate distributing the roles of every client across the network and can instead install the policies pertaining to the destination that are directly attached to the egress switch.

For example, network switch 104 can be aware of a role, e.g., finance role, associated with client device 116 and may install policies that pertain to finance as the destination client role. Similarly, network switch 106 can be aware of client role, e.g., admin, associated with client device 112 and may install policies pertaining to corresponding client role admin. Likewise, network switch 108 can be aware of client roles associated with client devices 120 and 122, e.g., client device 120 can be associated with finance role and client device 122 can be associated with admin role. Therefore, network switch 108 may install policies pertaining to both the roles, i.e., finance and admin.

Further, in existing systems an authenticated client can be associated with a role based on the MAC address of the client. When a packet arrives from an authenticated client, e.g., client 116, the system may identify, based on a MAC SA table that client 116 is classified under a role, e.g., engineer role, and may apply appropriate policies pertaining to engineer role.

However, there are different use cases in which it is desirable to perform profiling of the sender which is not based on the role obtained during authentication but rather based on other attributes like IP, sub-net, source port, etc. For example, some switch ports can represent trusted ports and can be physically accessible to an administrator. In such a case, client devices that are plugged into such trusted ports may not be authenticated. When a user plugs a device into such trusted ports, the system may not receive authentication packets and hence may find it difficult to classify the device into a specific role or group to apply appropriate policies. To enable classification of such packets, additional hardware features has to be integrated in the ASICs of the existing systems which can be expensive. Some of the aspects described in this application provide a solution to this above-mentioned technical problem by alleviating the use of expensive additional hardware to perform port-based role identification.

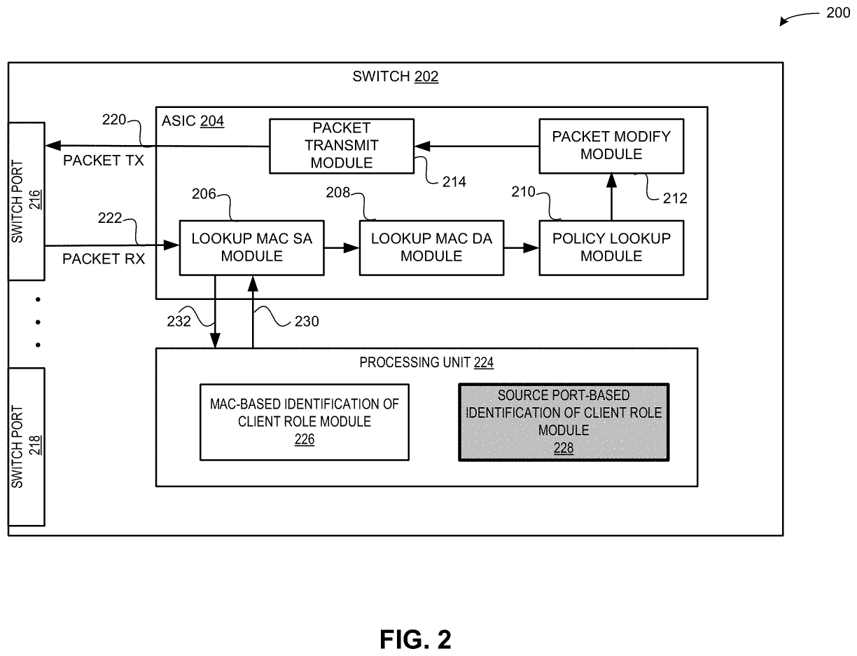

When performing micro-segmentation, classifying users based on the port via which the clients connect can have various applications. Existing network switches can support GBP and dynamic segmentation, but support source profiling based on the MAC of the sender. Although, individual source profiling based on MAC can be a common use-case for micro-segmentation deployment, it is desirable to support additional profiling schemes to support new applications and segmentation. For example, port-based profiling is one such additional profiling scheme that most of the existing network devices do not support. One aspect described in this application, can perform such port-based profiling by initially identifying a global trusted port configuration that corresponds to a default client role assigned to the client device coupled to a trusted port of the network device. Applying such a global trusted port configuration can result in assigning a common default client role to client devices connected to the trusted ports. The system can then determine whether a per-port configuration exists for the trusted port in a port-based role mapping table. In response to determining that the per-port configuration exists for the trusted port in the port-based role mapping table, the system may update a MAC SA table maintained in hardware with the port-based role, thereby overriding the global trusted port configuration. The integration of port-based profiling in existing network devices is described below in reference to FIGS. 2-6.

FIG. 1B illustrates an example mapping between a client role, VLAN, and MAC address, according to one aspect of the instant application. In the example shown in FIG. 1B, a client 1, i.e., client 116 in FIG. 1A, can be associated with VLAN 100, client role finance, and Layer-2 VxLAN network identifier (L2VNI 1000). Likewise, each client is associated with a different client role based on the client MAC address and VLAN in which it is placed. The mapping shown in FIG. 1B can represent a mapping in a MAC SA table maintained by the system ASIC.

FIG. 2 illustrates an example system architecture for facilitating a source port-based identification of client role, according to one aspect of the instant application.

In this example system architecture 200, a network switch 202 can include an ASIC 204, processing unit 224, e.g., a central processing unit (CPU) or a processor, and a number of network switch ports, e.g., 216 and 218, to which a respective client device can connect. ASIC 204 can include a set of modules 206-214 for applying networking policies to incoming packets 222, e.g., packets received via network switch port 216.

In the current network devices that support GBP, the network device ASIC can provide an interface to program individual tags, i.e., user roles, against the source MAC of a locally attached sender or client device, in a MAC SA table. Traditionally, the system in the current network devices can assign this tag (or user role) for the clients on-boarded via a port-access method over a secure port. The system can apply the user role obtained during the on-boarding to derive a group tag to program or update the MAC SA table. The system may apply a default tag to the other clients connected via other ports, e.g., non-secure port, trusted port, etc. Therefore, with such an assignment of group tags the current systems are not able perform further differentiation of the traffic sourced from such clients.

In some of the aspects described in this application, the system can assign SGTs to clients based on a port configuration. Specifically, when a packet from a client device arrives at a switch port, e.g., port 216, the system may apply a lookup MAC SA module 206 to determine whether the MAC address associated with the client device has a tag configured in the MAC SA table. When the system determines that there is no tag configured in the MAC SA table, the system may send a notification 232 to processing unit 224, or whenever a client device is plugged into a network switch port, e.g., switch port 216, ASIC 204 may send a MAC learn notification 232 to processing unit 224. In one aspect of this application, the system may buffer received packet 222 until processing unit 224 updates the MAC SA table with a GBP tag, e.g., a port specific SGT.

In response to receiving notification 232, the system may apply MAC-based identification of client role module 226 to determine a user role during a MAC authentication process when the client device is coupled to a secure port. Based on this user role and a first mapping table, i.e., MAC-based role table, module 226 can first derive an initial tag or role, e.g., finance role, for clients connecting over the secure port.

However, for non-secure ports where no port access on-boarding is applied, module 226 may initially apply a global default tag. The system may subsequently apply a source-port based identification of client role module 228 to determine, based on a second mapping table, i.e., a port-based role table, whether the source port includes a port specific SGT configuration. In response to module 228 determining that the second mapping table includes a port specific SGT configuration for source port 216, module 228 can select the port specific SGT, e.g., admin role or tag, corresponding to port 216, thereby overriding the initial tag, (which was e.g., a finance role or tag). The system can then update 230 the MAC SA table with the port specific SGT corresponding to the source MAC address. Therefore, the system can re-purpose the MAC SA table to include port-specific tags and can hence facilitate the application of GBPs based on the port-specific tags.

In response to the system updating the MAC SA table with the tag determined in processing unit 224, the system may send the buffered packet from processing unit 224 to an ingress pipeline, i.e., ingress pipeline can include modules 206-212. In other words, the system can apply lookup MAC SA module 206 again to identify a tag associated MAC SA of the client device. Since the system has updated the MAC SA table with an appropriate tag, the look-up will be successful. ASIC 204 may then apply a corresponding policy to the subsequent received packets based on the port-based client role identifier or tag and can then transmit packets 220 to the network. This novel approach of determining a port-based client role identifier and applying a policy based on the identifier can address a number of uses cases. Some of these use cases are described in the following paragraphs.

Classifying clients based on a port via which they connect can have multiple applications. For example, it may be useful to classify trusted clients like servers that connect via trusted ports on which no port-access authentication mechanism is applied. Clients connected over such ports can often host relevant services, e.g., Dynamic Host Configuration Protocol (DHCP), Remote Authentication Dial-In User Service (RADIUS), etc., which can be integral to proper functioning of the network. Therefore, it is desirable for a system to distinguish traffic from such clients and apply appropriate network access privileges to such traffic.

In another example use-case, multiple clients with similar attributes can connect over a one type of switch port. These clients can have different user roles, e.g., in an IoT deployment, there may be user groups belonging to roles such as sensors, camera, actuators, etc., but may be associated with similar network access privileges. An aggregation of such user roles can be possible with the use of a port-based user/client role.

In another use-case, the system may apply port-based client role for traffic arriving externally, such as the Internet traffic. It may be desirable to apply some restrictions on such traffic which will be specific to such traffic. Traditional ACL based restrictions may not work when multiple user roles exist on the similar network segment with each user having a different level of access permissions. Therefore, it is desirable to have a system that can classify traffic arriving via uplink ports from external sources with a specific port-based tag.

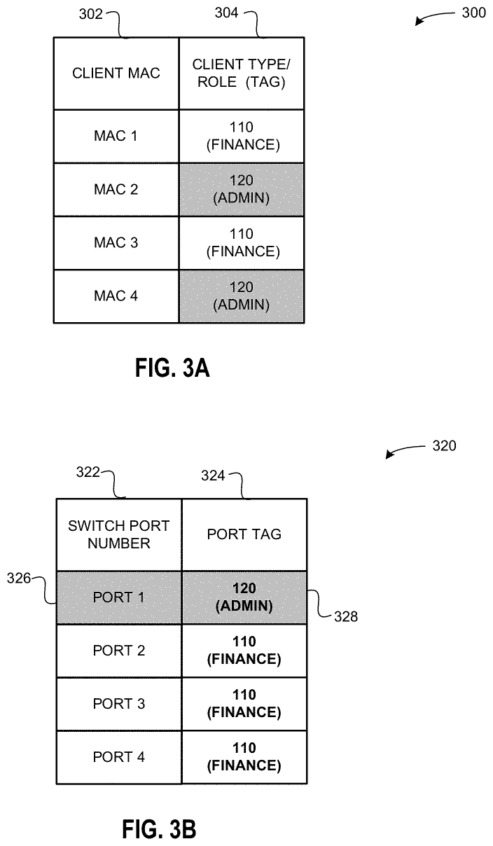

In one aspect of this application, the system can maintain one or more mapping tables, e.g., a first mapping table and a second mapping table. The first mapping table can include a mapping between the client role and the client MAC address, while the second mapping table can include a mapping between a port-based client role and a port identifier. An example of the first and the second mapping tables are described below in reference to FIGS. 3A and 3B, respectively.

FIG. 3A illustrates an example first mapping table indicating a mapping between a client role and a client device MAC address, according to one aspect of the instant application. In the example shown in FIG. 3A, first mapping table 300 can include columns 302 and 304 (the number of columns can vary to include other parameters). Column 302 can represent client MAC addresses and column 304 can represent client roles. When a client with MAC address MAC 1 is coupled to a network switch, the system may identify during an authentication process that the client device with MAC 1 has a finance role. The system may update table 300 with an identifier for the identified role, e.g., the identifier can be an integer value 110. The system may then set this identifier or tag as the initial tag.

FIG. 3B illustrates an example second mapping table indicating a mapping between a switch port and port tag, according to one aspect of the instant application. In the example shown in FIG. 3B, second mapping table 320 can include columns 322 and 324 (the number of columns can vary). Column 322 can represent a switch port number and column 324 can represent a port tag which indicates a client role configured on a switch port. When a client with MAC address MAC 1 is coupled to a network switch via port 1, the system may identify during an authentication process that the client device with MAC 1 has a finance role (based on the first mapping table in FIG. 3A). The system may update table 300 (shown in FIG. 3A) with an identifier for the finance role, i.e., 110. The system may then set identifier 110 or tag as the initial tag. The system determines based on second mapping table 320 whether the switch port via which the client device with MAC 1 is coupled has a port configuration.

Assume that the client device with MAC 1 is coupled to switch port 1. The system may identify from second mapping table 320 that port 1 326 is configured in a way that role of admin 328, i.e., client role identifier 120, is assigned to any client device, i.e., irrespective of their MAC address, coupled to switch port 1. The system may retrieve this new identifier associated with the client device and override the initial tag, i.e., finance role having identifier 110, with the new identifier, i.e., admin role 328 having identifier 120, based on the port configuration included in second mapping table 320. The system may then apply a corresponding policy based on the client role identifier or

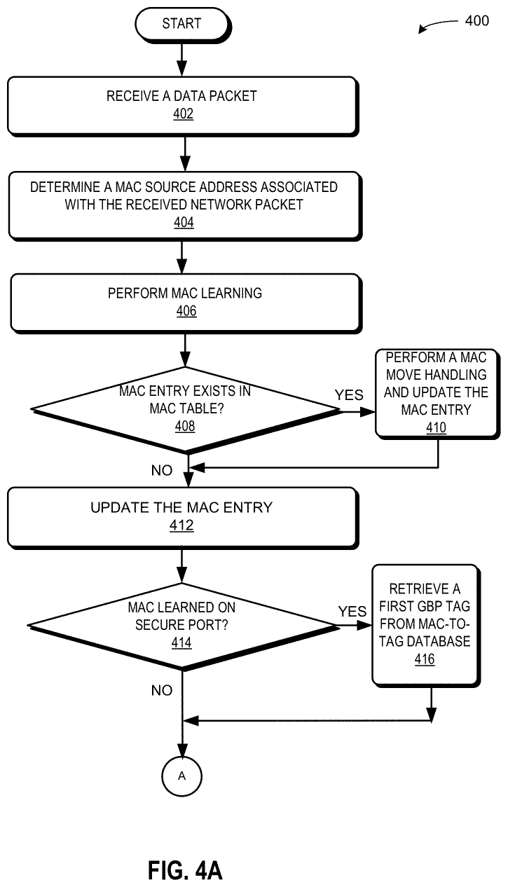

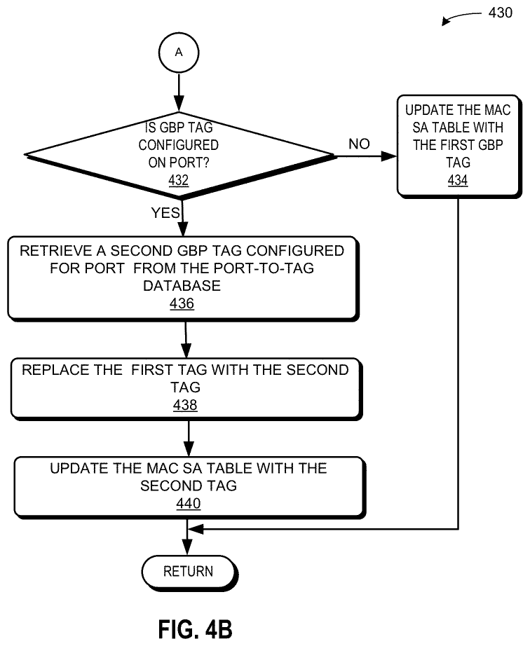

FIGS. 4A and 4B present flowcharts illustrating an example process for performing a source port-based identification of a client role, according to one aspect of the instant application. Referring to flowchart 400 in FIG. 4A, during operation, the system can receive a network packet (operation 402) from a client device coupled to a switch port of a network switch. The system may extract a MAC source address of the client device from the received network packet (operation 404). If the network packet is received from an authenticated client, then the system has already updated a MAC SA table with a corresponding client role that the system had learnt during a previous authentication process associated with the client device. In such a case a MAC SA lookup may be successful, and the system may find a tag (or a client role) associated with the MAC SA of the client device. In such a case, the system may perform a policy lookup based on the tag and apply a corresponding policy to the received network packets.

However, when the system determines that one or more of conditions are satisfied (e.g., the network packet is received from a client that is not authenticated; an associated tag is not present in the MAC SA table; a certain time, e.g., ten minutes, one hour, or 10 days, has lapsed since the previous authentication; the client device is connected on a different switch port when compared to that during the previous authentication process), the system may enable the network switch ASIC to forward the processing to a processing unit for performing a MAC learning process (operation 406). Identifying an unauthenticated client is desirable, otherwise a user may connect a client device, e.g., a laptop, into a network switch port and may start sending packets which can result in a security lapse. Therefore, it is desirable that the system can identify and apply appropriate GBP to such network packets.

Further, when the system determines that a user disconnected from a switch port and has connected to another switch port, e.g., a secure switch port, associated with the network switch, the system may invalidate the previous client role entry in the MAC SA table and re-initiate the authentication process. The processing unit may perform MAC learning to determine a MAC SA associated with the received network packet (operation 406). The processing unit may then determine whether an entry exists for the MAC SA in a first mapping table (operation 408). In response to determining that an entry corresponding to the MAC SA exists in the first mapping table, the processing unit may perform a MAC move handling and update the first mapping table with a new tag or client role associated with the client device based on the re-initiated authentication process (operation 410).

Specifically, when the client device is connected to a different secure switch port when compared to a previously connected switch port or the client disconnects from a current switch port and connects again to the switch port after a certain time, e.g., ten minutes or ten days, the processing unit may identify this move or change and perform move handling. In other words, the system may re-initiate an authentication process to retrieve a new client role and update the first mapping table with the new client role or a first GBP tag and a corresponding MAC SA of the client device.

In response to determining that an entry for the MAC SA in the packet does not exist in the first mapping table, the processing unit may update the first mapping table with the MAC SA and a corresponding client role (operation 412).

The processing unit may then determine whether the network packet is received from a secure port or a non-secure port (operation 414). When the processing unit determines that the network packet is received from a secure port (this indicates that the connected client device is already authenticated), the processing unit may retrieve a first GBP tag corresponding to the MAC SA associated with the client device from the first mapping table, i.e., from the MAC-to-tag database (operation 416). In response to retrieving the first GBP tag from the first mapping table, the processing unit may continue to operations indicated at label A (see FIG. 4B).

In response to determining that the network packet is received from a non-secure port or a trusted port, the processing unit may continue to operations indicated at label A (see FIG. 4B). In one aspect described in this application, during the MAC learning process the system may determine whether the client device is connected to a non-secure port or a trusted port. When a client device is connected to non-secure or a trusted port of the network device the system may not authenticate the client device. In such a case, the system may assign, based on a first mapping table, a global default client role when the client device is connected to a non-secure port and may assign a default client role when the client device is connected to a trusted port.

Referring to flowchart 430 in FIG. 4B, the processing unit may determine whether a GBP tag is configured for the switch port on which the network packet was received (operation 432). For example, during the authentication process an authentication service may assign an engineer role to the client device coupled to the network switch via a secure switch port. But a system administrator may configure a different role for the switch port, e.g., an intern role. This means that irrespective of the role assigned to the client device coupled to the secure switch port during the authentication process, the system would assign the role of an intern to any client device that connects to that secure switch port, thereby overriding the engineer role with the intern role.

Therefore, the processing unit instead of providing the first GBP tag (e.g., a client role, a default client role, or a global default client role) learnt from the first mapping table to the MAC SA table, may look-up a second mapping table, i.e., a port-to-tag database, to determine whether another GBP tag is configured for the switch port. When the processing unit determines that the second mapping table does not include a GBP tag configured for the switch port, the processing unit may update the MAC SA table, maintained in the ASIC, with first GBP tag (e.g., a client role, a default client role, or the global default client role) obtained from the first mapping table (operation 434) and the operation returns.

When the processing unit determines that the second mapping table includes a second GBP tag, i.e., a port specific tag, configured for the switch port, the processing unit may retrieve the second GBP tag from the second mapping table (operation 436). The processing unit may override or replace the first GBP tag that was retrieved from the first mapping table with the second GBP tag (operation 438). The processing unit may then update the MAC SA table with the second GBP tag obtained from the second mapping table and the operation returns. The system may then enable the ASIC to apply the second GBP tag updated in the MAC SA table to perform policy lookup and process the subsequent network packets via the switch port accordingly. The ASIC or circuitry implementing the policy engine can be aware of the mapping between the MAC SA and a GBP tag (e.g., a MAC-based tag), the circuitry is however not aware of a mapping between the MAC SA and the port-based tag. The system can re-purpose the MAC SA table by replacing the MAC-based tag with a port-based tag, so that the circuitry can apply this port-based tag to perform a policy look-up and apply an appropriate policy to the network packets received via a specific switch port.

### Computer System Facilitating Port-Based Role Identification

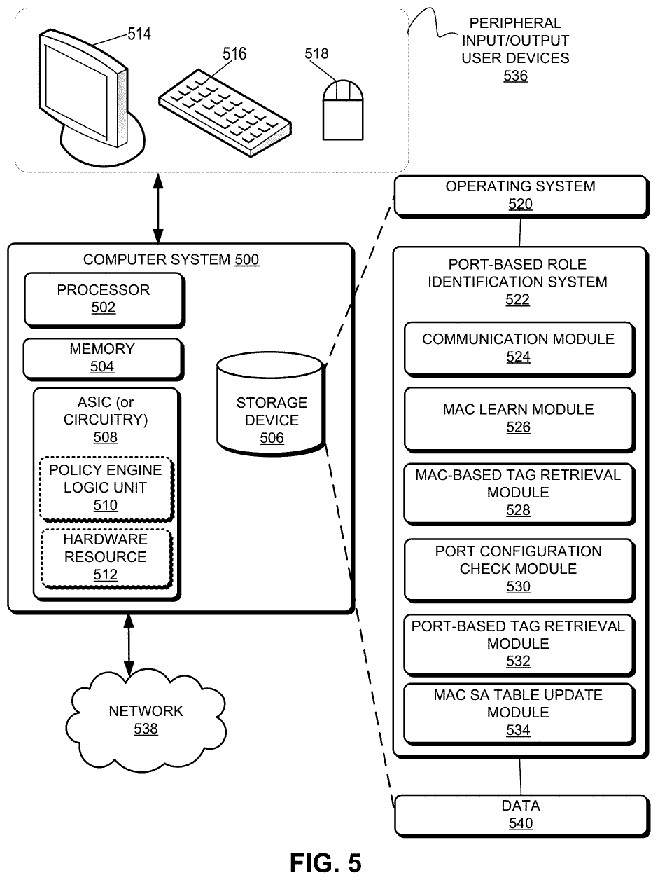

FIG. 5 illustrates an example computer system that facilitates a source port-based identification of client role, according to one aspect of the instant application. In this example, computer system 500 can include a processor 502, a memory 504, a storage device 506. Computer system 500 can be coupled to peripheral input/output

(I/O) user devices 536, e.g., a display device 514, a keyboard 516, and a pointing device 518. Storage device 506 can store instructions for an operating system 520, a port-based role identification system 522, and data 540. Data 540 can include any data that is desirable as input or that is generated as output by the methods and/or processes described in this disclosure. Computer system 500 can be coupled via one or more network interfaces to a network 538.

Computer system 500 can be equipped with an ASIC or a circuitry 508 which can include a policy engine logic unit 510 and hardware resources 512, e.g., memory, to accommodate a MAC SA table and one or more policy lookup tables.

In one aspect of this application, port-based role identification system 522 can include instructions, which when executed by processor 502 can cause computer system 500 to perform methods and/or processes described in this disclosure. Port-based role identification system 522 can include a communication module 524 for sending network packets to other nodes in network 538 via ASIC 508, i.e., ASIC 508 can apply one or more policy rules before sending the packets to other nodes in network 538. Communication module 524 can also receive/obtain network packets from other network nodes in network 538 via a network interface. Port-based role identification system 522 can further include instructions for implementing a MAC learn module 526 for determining whether a MAC SA identified in a received network packet, i.e., MAC SA associated with a client device from which the network packet is received, exists in a MAC SA table. Further, MAC learn module 526 can update a first mapping table, e.g., stored in memory 504, with the MAC SA and a client role learnt during an authentication process.

Port-based role identification system 522 can include a MAC-based tag retrieval module 528 to retrieve a first GBP tag or a first role corresponding to the MAC SA from the first mapping table. When the client device is coupled to a secure port,

MAC-based tag retrieval module 528 may retrieve the first GBP tag that was added to the first mapping table during an authentication process. When the client device is coupled to a non-secure port, MAC-based tag retrieval module 528 may retrieve a global default tag or a global default client role from the first mapping table. Further, when the client device is coupled to a trusted port, MAC-based tag retrieval module 528 may retrieve a default tag reserved for trusted ports or a default client role from the first mapping table.

Port configuration check module 530 can determine whether there exists a per-port configuration associated with a switch port (via which a client device is coupled) in a second mapping table (which is also stored in a database, e.g., in memory 504).

For example, a per-port configuration can indicate that a second mapping table includes a second GBP tag corresponding to a switch port to which the client device is coupled. In response to determining that the per-port configuration is present in the second mapping table, port-based role identification system 522 can apply a port-based tag retrieval module 532 to retrieve the second GBP tag configured for the switch port.

Port-based role identification system 522 can include a MAC SA table update module 534 to update the MAC SA table with the second GBP tag (when a per-port configuration exists) thereby overriding or replacing the first GBP tag (e.g., device specific client role, reserved tag for trusted ports, or a global default client role for non-secure ports). Alternatively, MAC SA table update module 534 can update the MAC SA table with the first GBP tag when the per-port configuration does not exist for the switch port in the second mapping table.

One aspect described in this application can provide a system and method for facilitating a source port-based identification of a client role. During operation, the system can receive, at a network device, a network packet from a client device coupled to the network device via a port. The received network packet includes a client device identifier. The system can in response to determining that the port is a trusted port, apply a global trusted port configuration based on a first mapping table. The global trusted port configuration corresponds to a default client role assigned to the client device coupled to the trusted port of the network device. The first mapping table can indicate a mapping between a set of client roles and a set of client device identifiers.

Further, the system can in response to determining that a per-port configuration exists in a second mapping table and the client device is coupled to the trusted port, identify the per-port configuration that corresponds to a port-based client role to override the global trusted port configuration; and apply, based on the per-port configuration and a third mapping table, a policy to the subsequent network packets received via the port.

The second mapping table can include a mapping between a set of network device ports and a set of client roles. The third mapping table can include a mapping between the set of client roles and the set of client device identifiers.

In a variation on this aspect, the system can in response to determining that the per-port configuration exists in the second mapping table and the client device is coupled to the trusted port, update an entry in the third mapping table with the port-based client role corresponding to the client device identifier.

In a variation on this aspect, the system can in response to receiving the network packet via the port, determine whether the third mapping table includes the client device identifier and a corresponding client role. The system can in response to determining that the third mapping table includes the client device identifier and the corresponding third client role, determine whether one or more conditions are satisfied. The system can then in response to determining that the one or more conditions are satisfied, invalidate the client role and initiating a learning process to determine a new client role. Further, the system can in response to determining that the third mapping table does not include the client device identifier and the corresponding client role, initiating the learning process to determine the new client role.

In a variation on this aspect, the one or more conditions can include: the client device is re-coupled to the network device port after a threshold time period; and the client device is coupled to the network device port that is different from a previously coupled port.

In a variation on this aspect, the system can initiate the learning process by in response to determining that the port is a secure port, authenticating the client device; determining, based on the client authentication, a client role; and updating the first mapping table with the client device identifier and the client role.

In a variation on this aspect, the system can initiate the learning process by performing the following: in response to determining that the port is a non-secure port, identifying, based on the first mapping table, a global default client role; determining whether the port-based client role is configured for the port in the second mapping table; in response to determining that the port-based client role is configured for the port in the second mapping table, updating the third mapping table with the port-based client role; and in response to determining that the port-based client role is not configured for the port in the second mapping table, updating the third mapping table with the global default client role.

In a variation on this aspect, the system can in response to determining that the port is the trusted port and the port-based client role is not configured for the port in the second mapping table, updating the third mapping table with the default client role.

In a variation on this aspect, the default client role and the port-based client role are represented as integer values.

In a further variation, wherein the third mapping table is maintained in the network device hardware.

In a further variation, the client device identifier corresponds to a MAC address of the client device.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules or apparatus. The hardware modules or apparatus can include, but are not limited to, ASIC chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing descriptions of aspects have been presented for purposes of illustration and description. They are not intended to be exhaustive or to limit the scope of this disclosure to the forms disclosed. Accordingly, many modifications and variations will be apparent to practitioners skilled in the art.

What is claimed is:

1. A computer-implemented method comprising:
receiving, at a network device, a network packet from a client device coupled to the network device via a port, wherein the received network packet includes a client device identifier;
in response to determining that the port is a trusted port, applying a global trusted port configuration based on a first mapping table, wherein the global trusted port configuration corresponds to a default client role assigned to the client device coupled to the trusted port of the network device, wherein the first mapping table indicates a mapping between a set of client roles and a set of client device identifiers;
in response to determining that a per-port configuration exists in a second mapping table and the client device is coupled to the trusted port,
identifying the per-port configuration that corresponds to a port-based client role to override the global trusted port configuration, wherein the second mapping table includes a mapping between a set of network device ports and a set of client roles; and
applying, based on the per-port configuration and a third mapping table, a policy to the subsequent network packets received via the port, wherein the third mapping table includes a mapping between the set of client roles and the set of client device identifiers.

2. The computer-implemented method of claim 1, wherein in response to determining that the per-port configuration exists in the second mapping table and the client device is coupled to the trusted port, further comprising: updating an entry in the third mapping table with the port-based client role corresponding to the client device identifier.

3. The computer-implemented method of claim 1, further comprising:
in response to receiving the network packet via the port, determining whether the third mapping table includes the client device identifier and a corresponding client role;
in response to determining that the third mapping table includes the client device dentifier and the corresponding third client role, determining whether one or more conditions are satisfied;
in response to determining that the one or more conditions are satisfied, invalidating the client role and initiating a learning process to determine a new client role; and
in response to determining that the third mapping table does not include the client device identifier and the corresponding client role, initiating the learning process to determine the new client role.

4. The computer-implemented method of claim 3, wherein the one or more conditions include:
the client device is re-coupled to the port after a threshold time period; and
the client device is coupled to the port that is different from a previously coupled port.

5. The computer-implemented method of claim 3, wherein initiating the learning process comprises:
in response to determining that the port is a secure port, authenticating the client device;
determining, based on the client authentication, a client role; and
updating the first mapping table with the client device identifier and the client role.

6. The computer-implemented method of claim 3, wherein initiating the learning process comprises:
in response to determining that the port is a non-secure port, identifying, based on the first mapping table, a global default client role;
determining whether the port-based client role is configured for the port in the second mapping table;
in response to determining that the port-based client role is configured for the port in the second mapping table, updating the third mapping table with the port-based client role; and
in response to determining that the port-based client role is not configured or the port in the second mapping table, updating the third mapping table with the global default client role.

7. The computer-implemented method of claim 1, further comprising:
in response to determining that the port is the trusted port and the port-based client role is not configured for the port in the second mapping table, updating the third mapping table with the default client role.

8. The computer-implemented method of claim 1, wherein the default client role and the port-based client role are represented as integer values.

9. The computer-implemented method of claim 1, wherein the third mapping table is maintained in the network device hardware.

10. The computer-implemented method of claim 1, wherein the client device identifier corresponds to a Media Access Control (MAC) address of the client device.

11. A computer system, comprising:
a processor;
a circuitry coupled to the processor for implementing a set of policies; and
a memory coupled to the processor and storing instructions which, when executing by the processor, cause the processor to perform a method, the method comprising:
receiving, at a network device, a network packet from a client device coupled to the network device via a port, wherein the received network packet includes a client device identifier;
in response to determining that the port is a trusted port, applying a global trusted port configuration based on a first mapping table, wherein the global trusted port configuration corresponds to a default client role assigned to the client device coupled to the trusted port of the network device, wherein the first mapping table indicates a mapping between a set of client roles and a set of client device identifiers;
in response to determining that a per-port configuration exists in a second mapping table and the client device is coupled to the trusted port,
identifying the per-port configuration that corresponds to a port-based client role to override the global trusted port configuration, wherein the second mapping table includes a mapping between a set of network device ports and a set of client roles; and
applying, based on the per-port configuration and a third mapping table, a policy to the subsequent network packets received via the port, wherein the third mapping table includes a mapping between the set of client roles and the set of client device identifiers.

12. The computer system of claim 11, wherein in response to determining that the per-port configuration exists in the second mapping table and the client device is coupled to the trusted port, the method further comprising: updating an entry in the third mapping table with the port-based client role corresponding to the client device identifier.

13. The computer system of claim 11, the method further comprising:
in response to receiving the network packet via the port, determining whether the third mapping table includes the client device identifier and a corresponding client role;
in response to determining that the third mapping table includes the client device identifier and the corresponding third client role, determining whether one or more conditions are satisfied;
in response to determining that the one or more conditions are satisfied, invalidating the client role and initiating a learning process to determine a new client role; and
in response to determining that the third mapping table does not include the client device identifier and the corresponding client role, initiating the learning process to determine the new client role.

14. The computer system of claim 13, wherein the one or more conditions include:
the client device is re-coupled to the network device port after a threshold time period; and
the client device is coupled to the network device port that is different from a previously coupled port.

15. The computer system of claim 13, wherein initiating the learning process comprises:
in response to determining that the port is a secure port, authenticating the client device;
determining, based on the client authentication, a client role; and
updating the first mapping table with the client device identifier and the client role.

16. The computer system of claim 13, wherein initiating the learning process comprises further comprises:
in response to determining that the port is a non-secure port, identifying, based on the first mapping table, a global default client role;
determining whether the port-based client role is configured for the port in the second mapping table;
in response to determining that the port-based client role is configured for the port in the second mapping table, updating the third mapping table with the port-based client role; and
in response to determining that the port-based client role is not configured for the port in the second mapping table, updating the third mapping table with the global default client role.

17. The computer system of claim 11, the method further comprising:
in response to determining that the port is the trusted port and the port-based client role is not configured for the port in the second mapping table, updating the third mapping table with the default client role.

18. The computer system of claim 11, wherein the default client role and the port-based client role are represented as integer values.

19. The computer system of claim 11, wherein the third mapping table is maintained in the network device hardware.

20. The computer system of claim 11, wherein the client device identifier corresponds to a Media Access Control (MAC) address of the client device.
